(19) United States
(12) Patent Application Publication
(10) Pub. No.: US 2026/0316889 A1
(43) Pub. Date: Oct. 15, 2026

(54) Actuation Device for Actuating an Electric Gear Shift Mechanism for a Muscle-Powered Vehicle

(71) Applicant: ZF Friedrichshafen AG, Friedrichshafen (DE)

(72) Inventors: Alexander Jungaberle, Schlier (DE); Uwe Schraff, Markdorf (DE); Markus Wallner, Friedrichshafen (DE)

(21) Appl. No.: 19/117,189

(22) PCT Filed: Sep. 29, 2022
(86) PCT No.: PCT/EP2022/077238

§ 371 Date: Mar. 31, 2025

(51) Int. Cl. B62M 25/08; B62K 23/02

(52) U.S. Cl. CPC B62M 25/08; B62K 23/02

(57) ABSTRACT

An actuating device (1) for actuating an electric gear shift mechanism (2) for a muscle-powered vehicle includes a shifting device (3) for shifting a gear of the gear shift mechanism (2). The shifting device (3) is transferrable by a user of the vehicle into a first shifting state and into a second shifting state different from the first shifting state. The actuating device (1) also include a control device (5), which is configured to determine which shifting state the shifting device (3) is in. The control device is configured to output to the gear shifting mechanism (2) a shifting command for single shifting when the first shifting state is present and a shifting command for multiple shifting when the second shifting state is present.

### CROSS-REFERENCE TO RELATED APPLICATION

The present application is related and has right of priority to PCT Application No. PCT/EP 2022/077238 filed on Sep. 29, 2022, which is incorporated by reference in its entirety for all purposes.

### TECHNICAL FIELD

The present invention relates generally to an actuating device for actuating an electric gear shift mechanism for a muscle-powered vehicle. The muscle-powered vehicle can be a bicycle. The present invention also relates generally to a shifting assembly having such an actuating device and to a muscle-powered vehicle having such a shifting assembly.

### BACKGROUND

Derailleurs which can be both mechanically and electrically actuated, hub gears, and gear shift devices for bicycles are known from the prior art. A shift lever is provided for actuating the gear shift, which shift lever can be, for example, a trigger shifter.

Alternatively, rotary shifters are also used. In bicycles having electric assistance, for example, pedelecs, it is generally only possible to carry out shifts by one gear.

### BRIEF SUMMARY

Example aspects of the present invention provide an actuating device for actuating an electric gear shift mechanism for a muscle-powered vehicle. The muscle-powered vehicle can be a single-track vehicle, for example, a two-wheeled vehicle in the form of a pedelec or an e-bike. Alternatively, the muscle-powered vehicle can be a multi-track vehicle, for example, a three-wheeled vehicle or a vehicle having four wheels. The muscle-powered vehicle can also have another design. The electric gear shift mechanism can be a derailleur, a hub gear, or a gear shift device. The electric gear shift mechanism can be hard-wired or wireless. One example embodiment relates to an actuating device for actuating an electric gear shift mechanism, which is in the form of a transmission, for a muscle-powered vehicle in the form of a pedelec.

The actuating device has a shifting device for shifting, for example, upshifting or downshifting, a gear of the gear shift mechanism. When a gear is upshifted, the transmission ratio is increased, whereas the transmission ratio is decreased when a gear is downshifted. The shifting device can be actuated by a user of the vehicle in order to be transferred into a first shifting state and into a second shifting state different from the first shifting state. The first and the second shifting states of the shifting device can differ with respect to a position and/or orientation of a component of the shifting device. Alternatively or additionally, the first and the second shifting states can also differ with respect to a duration of actuation during which the shifting device is actuated by a user. In example embodiments, other distinguishing criteria between the first and the second states are also possible.

The actuating device has a control device, which can be an electrical control device, for example, a microcontroller. The control device is therefore specifically designed, for example programmed, to determine which shifting state the shifting device is in. For this purpose, the control device can receive the corresponding shifting state via transmission from the shifting device. For example, the shifting device can be designed to detect the particular shifting state of the shifting device and transmit the detected shifting state to the control device. In another example embodiment, the shifting device can transmit one or more signals, which are output, for example, by one or more sensors, to the control device in a hard-wired or wireless manner. In this case, the sensor device can be designed to determine, on the basis of the transmitted signals, which shifting state the shifting device is in.

In addition, the control device is designed to output to the gear shift mechanism a shifting command for single shifting if the first shifting state is present. Similarly, the control device is designed to output to the gear shift mechanism a shifting command for multiple shifting if the second shifting state is present. The shifting command can be a signal which can be output from the control device to the gear shift mechanism via an output interface. The shifting command can be an upshift command. In a single shift, the transmission ratio changes by one gear, whereas in a multiple shift, the transmission ratio changes by at least two gears, for example, two, three, four, or five gears. The gear shift mechanism can be designed to implement the shifting command for multiple shifting such that the multiple gears are shifted in one tap. In an example embodiment, the gear shift mechanism does not shift the multiple gears in one tap, but rather in multiple sequentially consecutive taps. In the latter case, the gear shift mechanism can therefore implement the shifting command for multiple shifts such that a single shift, i.e., a shift by one gear, is carried out multiple times one after the other.

With example aspects of the present invention, an electric gear shift mechanism is actuatable with particularly high flexibility. A user can carry out a gear change, either only by one gear but also by multiple gears simultaneously, with great flexibility using the actuating device according to example aspects of the present invention.

According to one example embodiment, the shifting device has a shifter with a shift position into which the shifter is transferrable by the user. The shifter can be a rotary shifter, for example, a trigger shifter. The shifter can be rotated by the user in a first direction of rotation to upshift the gear shift mechanism and into an opposite second direction of rotation to downshift the gear shift mechanism. The shifting device can have a preloader with a preload force, counter to which the shifter is transferrable by the user into the shift position. The shifter can have such a shift position with such a preloader both in the upshift direction and in the downshift direction. The preloader can be a spring. In addition, the actuating device according to this example embodiment has a detection mechanism for detecting a shifting duration during which the shifting device is held by the user in the shift position. The shift position can be a pressure point which is noticeable by the user and which the user perceives when actuating the shifter. The detection mechanism can be integrated in the shifting device or mounted on the shifting device. Alternatively, the detection mechanism can also be provided separately from the shifting device and, for example, spatially separated from the shifting device. The detection mechanism can include one or multiple sensor(s).

The shifting device can be in the first shifting state when the shifter is held in the shift position for a first shifting duration. This first shifting duration can be detected by the detection mechanism of the actuating device. Furthermore, the shifting device can be in the second shifting state when the shifter is held in the shift position for a second shifting duration, which is different from the first shifting duration. As described above, the determination as to which shifting state the shifting device is in can be carried out by the shifting device, the detection mechanism, the control device, or any combination thereof. The shifting duration can be determined by a timer, for example, in seconds. With the present example embodiment, an actuating device can therefore be provided, with which two different shifting states, specifically a shifting state for single shifting and a shifting state for multiple shifting, of a gear shift mechanism can be easily provided. The shifting device is very user friendly, since the various functionalities can be represented using only one shift position of the shifter.

Furthermore, the control device can be designed to output to the gear shift mechanism a shifting command, for example, an upshift command, for shifting a gear, wherein the number of gears to be shifted with the shifting command increases as the shifting duration increases. In other words, the user can simultaneously shift that many more gears using the actuating device according to example aspects of the present invention, the longer the user holds the shifter in the shift position. According to this example embodiment, a particularly intuitive operation of the gear shift mechanism is possible using the actuating device according to example aspects of the present invention.

According to one example embodiment, the shifting device has a shifter with multiple shift positions situated one after the other along an actuation direction. The shifter can be a rotary shifter, for example, a trigger shifter according to the description presented above. The rotary shifter can have a first direction of rotation for upshifting the gear shift mechanism and a second direction of rotation for downshifting the gear shift mechanism. The actuation direction can be a direction of rotation of the shifter. According to the present example embodiment, the shifter can thus have multiple shift positions situated one after the other in one direction of rotation. The shift positions can each be a noticeable pressure point, as described above. The shifter can have one or multiple preloaders having a preload force, counter to which the shifter can be transferred into the particular shift position. For example, the shifter can be transferred counter to the preload force of a first preloader into the first shift position, wherein the preload force can decrease or even disappear when the shifter is moved past the first shift position. If the shifter is then moved by the user in the actuation direction further towards the second shift position, the preloader or a further preloader can oppose this movement with a preload force, counter to which the user can transfer the shifter into the shift position. A corresponding example embodiment having a corresponding behavior can also be provided for a third shift position, a fourth shift position, or a further shift position. The shifter can have such a design and such a behavior both in a first direction of rotation for upshifting and in a second direction of rotation for downshifting the gear shift mechanism.

The particular shift positions of the shifter can correspond to a certain extent of actuating travel of the shifter along the actuation direction, i.e., to a displacement of the shifter along the actuation direction. The shifting device can be in the first shifting state, in which a command for single shifting is output to the gear shift mechanism, when the shifter is in a first shift position. Furthermore, the shifting device can be in the second shifting state in which, by the control device, a command for multiple shifting is output to the gear shift mechanism, when the shifter is in a second shift position. The second shift position can be different from the first shift position, for example, the second shift position can have a different extent of actuating travel along the actuation path. With this example embodiment, an actuating device for an electric gear shift mechanism for single shifting and multiple shifting of the gear shift mechanism in a particularly user-friendly manner can be provided. By the present example embodiment, the user can particularly quickly select whether a single shifting or a multiple shifting of the gear shift mechanism is to be carried out.

The control device can be designed to output to the gear shift mechanism a shifting command for shifting a gear, wherein the number of gears to be shifted with the shifting command increases as the extent of actuating travel of the shifter increases along the actuation direction. With the present example embodiment, that many more gears can be shifted using the actuating device, the farther the shifter is moved by the user along the actuating direction. In the end, an actuating device is provided that is particularly intuitively actuatable by the user.

According to one example embodiment, the actuating device includes a detection mechanism and a shifting device having a shifter with multiple shift positions situated one after the other along an actuating device according to one of the above-described example embodiments. In this example embodiment, the shifter can have, for example, two shift positions situated one after the other in one actuation direction, for example, an upshift direction of the shifter. The shifter can also have two shift positions in both a first actuation direction, for example, an upshift direction, and in a second, opposite actuation direction, for example, a downshift direction. The shifting device can be in the first shifting state for the single shifting of a gear when the shifter is in the first shift position. Furthermore, the shifting device can be in the second shifting state for multiple shifting when the shifter is in the second shift position. The second shift position can be associated with a greater extent of actuating travel than that of the first shift position. The detection mechanism can be arranged and designed to detect a shifting duration during which the user holds the shifter in the first and/or the second shift position.

The control device can be designed to output to the gear shift mechanism a plurality of shifting commands for single shifting. In other words, the control device outputs to the gear shift mechanism multiple separate commands sequentially one after the other for shifting by one gear in each case. The number of multiple separate commands output to the gear shift mechanism by the control device can depend on the shifting duration detected by the detection mechanism, during which shifting duration the shifter is held in the first shift position. The longer this shifting duration is, the greater is the number of commands for single shifting that can be output to the gear shift mechanism by the control device. The individual commands for shifting can be output at intervals of, for example, one thousand (1000) milliseconds. This interval can be adjustable by the user of the vehicle, for example, via the human-machine interface described in the following.

Furthermore, the control device can be designed to output to the gear shift mechanism a shifting command for multiple shifting, wherein the number of gears to be shifted with the shifting command depends on a shifting duration detected by the detection mechanism, during which the shifter is held by the user in the second shift position. The longer the user holds the shifter in the second shift position, the greater is the number of gears that can be shifted simultaneously with a command which is output by the control device to the gear shift mechanism. In an alternative example embodiment, the control device can also be designed such that the control device continues shifting the gears step by step when the shifter has been transferred to the second shift position and held in this position by the user. The control device can be, for example, electrically connected to a display on which the target gear is displayed. As a result, by pressing for a long time up to the second shift position, it is possible to shift through to the lowest gear or the highest gear of the gear shift mechanism. The present example embodiment provides the advantage that an actuating device having a particularly high variability of shifting for the user can be provided. Therefore, the user can respond to changing surroundings conditions in a particularly variable manner and transfer the gear shift mechanism into an optimal state in a flexible and time-efficient manner.

According to one example embodiment, the control device also has a human-machine interface, via which the shift position or the multiple shift positions of the shifter of the shifting device, i.e., the extent of actuating travel of the shifting device, can be individually adjustable by the user. Alternatively or additionally, the shifting duration detected by the detection mechanism can also be adjusted via the human-machine interface, via which shifting duration the different states of the shifting device can be defined, as described above. Further parameters of the gear shift can also be individually adjustable by the user via the human-machine interface. The human-machine interface can be connected to a display or another type of input device, which can be mounted on a bicycle handlebar. A user can individually adjust the particular parameters via the display and/or the other input device. The human-machine interface can also include a point of connection to a mobile terminal, for example, a cell phone, which can be implemented wirelessly, for example, via the Internet. Such a point of connection can include a cell phone application via which the user can individually adjust the particular parameters of the actuating device. With the present example embodiment, an actuating device having a particularly high level of variability is provided, which actuating device permits adaptation to the individual needs and requests of a user.

Example aspects of the present invention also provide a shifting assembly having an electric gear shift mechanism and an actuating device according to one of the above-described example embodiments. The electric gear shift mechanism can be a gear shift device, but also any other type of electric gear shift mechanism. The control device of the actuating device can have an output interface via which the electric gear shift mechanism can be electrically connected to the actuating device in a hard-wired or wireless manner. Example aspects of present invention also provide a muscle-powered vehicle having such a shifting assembly. With respect to the comprehension and the advantages of the individual features, reference is made to the aforementioned comments in conjunction with the example embodiments of the actuating device.

### BRIEF DESCRIPTION OF THE FIGURES

FIG. 1 shows a shifting assembly having an actuating device according to one example embodiment of the present invention.

FIG. 2 shows a shifting device of the actuating device of the shifting assembly from FIG. 1.

FIG. 3 shows an example embodiment of the actuating device of the shifting assembly from FIG. 1 according to one example embodiment of the present invention.

FIG. 4 shows an example embodiment of the actuating device of the shifting assembly from FIG. 1 according to one example embodiment of the present invention.

FIG. 5 shows an example embodiment of the actuating device of the shifting assembly from FIG. 1 according to one example embodiment of the present invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

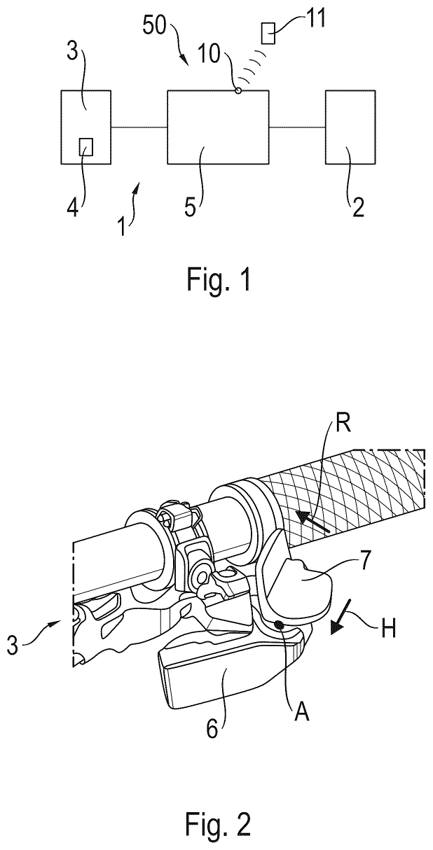

FIG. 1 shows a shifting assembly 50 for a muscle-powered vehicle according to one example embodiment of the present invention. The shifting assembly 50 can be part of a muscle-powered vehicle (not shown), for example, of a pedelec. The shifting assembly 50 has an actuating device 1 and an electric gear shift mechanism 2. The gear shift mechanism 2 in the present example embodiment is an electric gear shift device. The actuating device 1 has a shifting device 3, a detection mechanism 4, and a control device 5. In the present example embodiment, the detection mechanism 4 is part of the shifting device 3. In another example embodiment, the detection mechanism 4 is provided separately from the shifting device 3.

The shifting device 3 and the detection mechanism 4 are electrically connected to the control device 5 via an interface. Similarly, the gear shift mechanism 2 is electrically connected to the control device 5 of the actuating device 1. A user of the vehicle actuates the shifting device 3 of the actuating device 1 in order to change a gear of the vehicle by the gear shift mechanism 2. More precisely, the control device 5 of the actuating device 1 detects an actuation of the shifting device 3 by the user of the vehicle and, on the basis of this detection, outputs an electrical shifting signal to the gear shift mechanism 2 to change the gear.

FIG. 2 shows an example embodiment of the shifting device 3 of the actuating device 1 of the shifting assembly 50 from FIG. 1. As is apparent from FIG. 2, the shifting device 3 in the present example embodiment is a trigger shifter, which can be secured on a handlebar of a vehicle. The trigger shifter 3 has a shift rocker 7, which can be actuated by a finger of a user of the bicycle, for example, by the thumb. The shift rocker 7 is mounted rotatably about an axis of rotation A. In the present example embodiment, the rocker 7 is rotatable in a first direction for upshifting the gear shift mechanism 2 and in a second, opposite direction for downshifting the gear shift mechanism 2. The direction for downshifting is labeled with the reference character R in FIG. 2. The direction of rotation for upshifting the gear shift mechanism 2 is labeled with the reference character H in FIG. 2.

The rocker 7, which is rotatable about the axis A, is mounted on a housing 6 of the actuating device 1. A detection mechanism 4 (not shown in FIG. 2) is provided in the housing 6. The rocker 7 has at least one shift position both in the upshift direction H and in the downshift direction R, which shift position is in the form of a pressure point which is noticeable by the user in the present example embodiment. For this purpose, a preloader (not shown) having a preload force is provided in the shifting device 3, wherein the user can transfer the rocker 7 counter to the preload force of the preloader both into the shift position in the upshift direction H and into the shift position in the downshift position R. The detection mechanism 4 is arranged and designed such that the detection mechanism 5 can detect a shifting duration t during which the user holds the shift rocker 7 in one of the shift positions. The detection mechanism 4 can be, for example, a timer. Alternatively, the detection mechanism 4 can also have a sensor which outputs a signal to the control device 5 when the rocker 7 is held in the shift position by the user. One part of the detection mechanism 4 can then be embodied by the control device 5, which determines, on the basis of the sensor signal, the duration during which the rocker 7 is held in the shift position by the user. The shifting device 3 shown in FIG. 2 can provide one, two or more shift position(s) both in the upshift direction H and in the downshift direction R, which shift positions, in the present example embodiment, can be in the form of noticeable pressure points according to the aforementioned description.

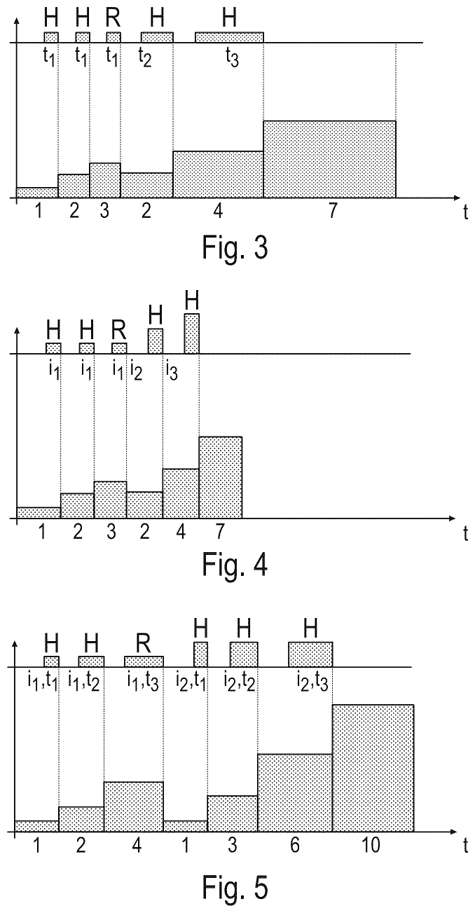

FIG. 3 shows an example embodiment of the actuating device of the shifting assembly 50 from FIGS. 1 and 2 according to one example embodiment of the present invention. In the example embodiment shown in FIG. 3, the shifting device 3 has only one single shift position, i.e., one single noticeable pressure point, both in the upshift direction H and in the downshift direction R. The detection mechanism 4 is designed to detect a shifting duration t during which the rocker 7 is held in the shift position in the upshift direction H or in the downshift direction R. The control device 5 in the example embodiment shown in FIG. 3 is designed to output a shifting command to the gear shift mechanism 2 such that the gear shift mechanism 2 shifts that many more gears, the longer is the shifting duration t which is detected by the detection mechanism 4.

If the gear shift mechanism 2 is in the first gear and if the shift rocker 7 is transferred in the upshift direction H into the single shift position and is held in this shift position for a shifting duration t1, the shifting device 3 is in a first shifting state, which is detected by the control device 5. The control device 5 is designed to output an upshift signal to the gear shift mechanism 2 for upshifting by one gear when the control device 5 detects that the shifting device 3 is in the first state. The gear shift mechanism 2 then shifts from the first gear into the second gear, as is apparent from FIG. 3. If this operation is repeated, i.e., the rocker 7 is once more transferred in the upshift direction H into the shift position and held in this position for a duration t1 by the user, the control device 5 once more outputs to the gear shift mechanism 2 a command for an upshift by one gear. The gear shift mechanism 2 then upshifts from the second gear into the third gear, as is apparent from FIG. 3. If the rocker 7 is then transferred by the user in the downshift direction R into the shift position and is held in this shift position for a duration t1, the control device 5 is designed to output to the gear shift mechanism 2 a command to downshift by one gear. The gear shift mechanism 2 therefore shifts from the third gear back to the second gear, since the shifting device 3 is in the first shifting state for the downshift direction R. If the user then actuates the rocker 7 such that the rocker is transferred in the upshift direction H into the shift position and is held in this shift position for a shifting duration t2, which is greater than and, for example, twice as great as the shifting duration t1, the shifting device 3 is in a second shifting state. The control device 5 is designed to detect that the shifting device 3 is in the second shifting state and to output to the gear shift mechanism 2 an upshift command to upshift by two gears. The gear shift mechanism 2 thus upshifts from the second gear to the fourth gear. If the user actuates the rocker 7 in the upshift direction H such that the rocker is held in the shift position for a shifting duration t3, which is greater than the shifting durations t1 and t2 and, for example, is three times as great as the shifting duration t1, the shifting device 3 is in a third shifting state which is detected by the control device 5. The control device 5 is designed to output to the gear shift mechanism 2 an upshift command to upshift by three gears. The gear shift mechanism 2 thus upshifts from the fourth gear to the seventh gear. Correspondingly, the control device 5 can be designed to output a shifting command by x gears for a shifting duration which is x-times as great as the shifting duration t1.

Alternatively to the example embodiment shown in FIG. 3, in which the shifting device 3 has only one single shift position in the upshift direction H and in the downshift direction R, the shifting device 3 can have multiple shift positions both in the upshift direction H and in the downshift direction R, which shift positions each have a noticeable pressure point according to the above-described example embodiment. The configuration of such an example embodiment is now described with reference to FIG. 4. As is apparent from FIG. 4, the actuating device 1 is designed such that the number of gears to be shifted depends on the extent of actuating travel i in the upshift direction H or in the downshift direction R. If the gear shift mechanism 2 is in the first gear and if the rocker 7 is deflected by the user in the upshift direction H only into the first shift position, the shifting device 3 is in a first shifting state. This first shifting state is detected by the control device 5, which is designed to output to the gear shift mechanism 2 a command to upshift by only one gear. The gear shift mechanism 2 thus shifts from the first gear into the second gear. If this operation is repeated, the control device 5 once again outputs to the gear shift mechanism 2 a command to upshift by one gear, which gear shift mechanism then shifts from the second gear to the third gear. In contrast, if the rocker 7 is deflected in the downshift direction R into the first shift position, i.e., the shifting device is transferred into the first shifting state, the control device 5 outputs to the gear shift mechanism 2 a command to downshift by one gear. The gear shift mechanism 2 thus shifts from the third gear to the second gear.

If the rocker 7 is then deflected in the upshift direction H by the user past the first shift position to the second shift position, the shifting device 3 is in a second shifting state which is detected by the control device 5. The control device 5 is then designed to output to the gear shift mechanism 2 an upshift command to upshift by two gears. The gear shift mechanism 2 then upshifts from the second gear to the fourth gear. The extent of actuating travel i2 for deflecting the shift rocker 7 into the second shift position can be twice as great as the extent of actuating travel i1 for deflecting the shift rocker 7 into the first shift position. If the user then deflects the rocker 7 in the upshift direction H past the first and the second shift positions into the third shift position, the shifting device 3 is in a third shift state. The control device 5 is then designed to output to the gear shift mechanism 2 an upshift command to upshift by three gears. The gear shift mechanism 2 thus upshifts from the fourth gear to the seventh gear. The extent of actuating travel i3 for deflecting the rocker 7 into the third shift position can be three times as great as the extent of actuating travel i1 for deflecting the rocker 7 into the first shift position. Correspondingly, the control device 5 can be designed to output to the gear shift mechanism 2 a command to shift by x gears when the rocker 7 is deflected into a shift position with an extent of actuating travel ix which is an x-fold of the extent of actuating travel i1 of the first shift position.

In the example embodiment described with reference to FIG. 5, the shifting device 3 has two shift positions both in the upshift direction H and in the downshift direction R, i.e., two pressure points, which are noticeable to the user according to the aforementioned example embodiment. The first shift position has an extent of actuating travel i1, which is half as great as the extent of actuating travel i2 for the second shift position. The example embodiment described with reference to FIG. 5 is designed such that the shifting device 3, when in the first shift position which has the extent of actuating travel i1, is in a first shift state for single shifting. In contrast, multiple shifts can be triggered by the user via the second shift position having the extent of actuating travel i2 in which the shifting device 3 is in a second shift state.

If the gear shift mechanism 2 is in, for example, the first gear and the user deflects the rocker 7 in the upshift direction H into the first shift position having the extent of travel i1 and holds the shifting device 3 in this shift state for a shifting duration t1, the shifting device 3 is in a first shift state. The control device 5 is then designed to output to the gear shift mechanism 2 an upshift command to upshift by one gear. The gear shift mechanism 2 then upshifts from the first gear to the second gear. If the user then repeats this operation but holds the rocker 7 in the first shift position in the upshift direction H for a duration t2, which is twice as great as the shifting duration t1, the control device 5 is designed to output to the gear shift mechanism 2 two successive and separate upshift commands to upshift by one gear in each case. The gear shift mechanism 2 then shifts from the second gear to the third gear and, thereafter, to the fourth gear. If the user then deflects the rocker 7 in the downshift direction R into the first shift position having the extent of travel i1 and holds the rocker 7 in this first shift position for a shifting duration t3, which is three times as great as the shifting duration t1, the shifting device 3 is in a third shift state. The control device 5 is then designed to output to the gear shift mechanism 2 three successive downshift commands to downshift by one gear in each case. The gear shift mechanism 2 then downshifts initially from the fourth gear to the third gear, from the third gear to the second gear, and from the second gear to the first gear. In the present example embodiment shown in FIG. 5, the detection mechanism 4 is therefore designed to detect a shifting duration t in the first shift state both in the upshift direction H and in the downshift direction R. In accordance with the detected shifting duration t, the control device 5 outputs to the gear shift mechanism 2 one or more shifting commands to shift by one gear in each case.

If the rocker 7 is deflected into the second shift position in the upshift direction H and is held in this second shift position for a duration t1, the shifting device 3 is in a second shift state. The control device 5 is designed to detect this second shift state and to output to the gear shift mechanism 2 a single upshift command to upshift by two gears. The gear shift mechanism 2 therefore upshifts by two gears, i.e., from the first gear to the third gear. Therefore, an upshift by two gears is initiated in one command and not by two successive, separate commands, as is the case when the rocker 7 is deflected into the first shift position. If the rocker 7 is then deflected again in the upshift direction H by the extent of travel i2 into the second shift position and is held in this second shift position for a shifting duration t2, which is twice as great as the shifting duration t1, the control device 5 is designed to output to the gear shift mechanism 2 an upshift command to upshift by three gears. The gear shift mechanism 2 thus upshifts from the third gear to the seventh gear. If the rocker 7 is deflected in the upshift direction H into the second shift position having the extent of actuating travel i2 and is held in this second shift position for a shifting duration t3, which is three times as great as the shifting duration t1, the control device 5 is designed to output to the gear shift mechanism 2 an upshift command to upshift by four gears. The gear shift mechanism 2 thus upshifts from the sixth gear to the tenth gear.

The control device 5 can also have a human-machine interface 10 via which a user can individually adapt and adjust the different shifting durations t1, t2, t3, and tx and, alternatively or additionally, the extents of actuating travel i1, i2, i3, or ix. The human-machine interface 10 can include, for example, a cell phone application 11 via which the user can adapt and adjust the parameters. Alternatively or additionally, the human-machine interface 10 can be implemented by a bicycle computer, which can provide, in addition to these adjustment options, even further functionalities as well, for example, displaying a ground speed or acting as a navigation system.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 actuation device
2 gear shift mechanism
3 shifting device
4 detection mechanism
5 control device
6 housing
7 rocker
10 human-machine interface
11 cell phone application
50 shifting assembly
H upshift direction
R downshift direction
A axis of rotation
t shifting duration
i extent of actuating travel

11. An actuating device (1) for actuating an electric gear shift mechanism (2) for a muscle-powered vehicle, comprising:
a shifting device (3) for shifting a gear of the gear shift mechanism (2), the shifting device (3) transferrable by a user of the vehicle into a first shifting state and into a second shifting state different from the first shifting state; and
a control device (5) configured to determine a current shifting state of the shifting device (3) and to output to the gear shifting mechanism (2) a shifting command for single gear shifting when the first shifting state is the detected current shifting state and for multiple gear shifting when the second shifting state is the detected current shifting state.

12. The actuating device (1) of claim 11, wherein the shifting device (3) comprises:
a shifter (7) with a shift position into which the shifter is transferrable by the user; and
a detection mechanism (4) for detecting a shifting duration (t) during which the shifting device (3) is held in the shift position by the user.

13. The actuating device (1) of claim 12, wherein:
the shifting device (3) is in the first shifting state when the shifter (7) is held in the shift position for a first shifting duration (t1); and
the shifting device (3) is in the second shifting state when the shifter (7) is held in the shift position for a second shifting duration (t2; t3), which is different from the first shifting duration (t1).

14. The actuating device (1) of claim 13, wherein:
the control device (5) is configured to output to the gear shift mechanism (2) the shifting command for shifting the gear of the gear shift mechanism (2); and
the number of gears to be shifted with the shifting command increases as the shifting duration (t) increases.

15. The actuating device (1) of claim 12, wherein:
the control device (5) is configured to output to the gear shift mechanism (2) a plurality of shifting commands for the single gear shifting;
the number of shifting commands for the single gear shifting depends on a shifting duration (t) detected by the detection mechanism (4), during which shifting duration the shifter (7) is held by the user in the first shifting position (i1);
the control device (5) is configured to output to the gear shift mechanism (2) a shifting command for the multiple gear shifting; and
the number of gears to be shifted with the shifting command for the multiple gear shifting depends on the shifting duration (t) detected by the detection mechanism (4), during which shifting duration the shifter (7) is held in the second shifting position (i2) by the user.

16. The actuating device (1) of claim 12, wherein the control device (5) comprises a human-machine interface via which one or both of the shift position (i) and the shifting duration (t) is adjustable by a user.

17. The actuating device (1) of claim 11, wherein the shifting device (3) comprises:
a shifter (7) with a plurality of shift positions (i1, i2, i3) situated in series along an actuation direction (H; R);
the shifting device (3) is in the first shift state when the shifter (7) is in a first shift position (i1); and
the shifting device (3) is in the second shift state when the shifter (7) is in a second shift position (i2; i3), which is different from the first shift position (i1).

18. The actuating device (1) of claim 17, wherein:
the control device (5) is configured to output to the gear shift mechanism (2) the shifting command for shifting the gear of the gear shift mechanism (2); and
the number of gears to be shifted with the shifting command increases as the extent of actuating travel (i) of the shifter (7) increases along the actuation direction (H;
R).

19. The actuating device (1) of claim 17, wherein:
the control device (5) is configured to output to the gear shift mechanism (2) a plurality of shifting commands for the single gear shifting;
the number of shifting commands for the single gear shifting depends on a shifting duration (t) detected by the detection mechanism (4), during which shifting duration the shifter (7) is held by the user in the first shifting position (i1);
the control device (5) is configured to output to the gear shift mechanism (2) a shifting command for the multiple gear shifting; and
the number of gears to be shifted with the shifting command for the multiple gear shifting depends on the shifting duration (t) detected by the detection mechanism (4), during which shifting duration the shifter (7) is held in the second shifting position (i2) by the user.

20. The actuating device (1) of claim 17, wherein the control device (5) comprises a human-machine interface via which one or both of the shift position (i) and the shifting duration (t) is adjustable by a user.

21. A shifting assembly (5), comprising an electric gear shift mechanism (2) and the actuating device (1) of claim 11.

22. A muscle-powered vehicle, comprising the shifting assembly (50) of claim 21.
